(19) United States
(12) Patent Application Publication
(10) Pub. No.: US 2005/0108272 A1
(43) Pub. Date: May 19, 2005

(54) Intermediate software layer

(76) Inventors: Christian Behrens, Leimen (DE); Volker Paul, Ruelzheim (DE); Steffen Rotsch, Rauenberg (DE); Rene Dehn, Sinshelm (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/713,623

(22) Filed: Nov. 13, 2003

(51) Int. Cl. G06F 17/00

(52) U.S. Cl. 707/102

(57) ABSTRACT

A system for business processes performs one or more complex business processing functions. In one implementation, the system includes a user interface to collect data from a user and an intermediate layer to collect data from the user interface. The system also includes business logic that can process the data collected from the intermediate layer. The intermediate layer can be interposed between the user interface and the business logic and configured to rearrange data collected by the user interface into a format that is optimized for processing by the business logic.

### TECHNICAL FIELD

The present disclosure relates to an intermediate software layer for one or more users interacting with enterprise systems and business processes.

### BACKGROUND

Business systems typically offer a flexible user interface (UI) that allows users to enter data in various locations in the user interface. The UI may provide other flexible features for allowing the user to enter data, save and record information, and edit complex objects in a database. Some of the flexible features may allow the UI to be adaptable for various business systems, as well as being easily formatted and modifiable for various user roles and functions. The flexible UI features may also allow the UI to interact with one or more software layers. In one aspect, the UI may interact with an underlying software layer of business logic (BL). The BL layer may maintain, sort, and/or process the entered data for one or more business applications and databases. However, the underlying BL layer tends to be relatively inflexible. Consequently, data entered in the UI tends not to be easily formatted for BL layer use.

In other cases, a user enters and saves data in the UI in a series of steps, in which the BL processes changes in data between steps. For example, the user may enter data in the UI, and the BL may process the data and request more data from the user. In that case, the UI is updated, and the user enters the next item(s) of data in the UI. The BL processes the next item(s) of data, and requests more data from the user. This serial data entry and BL processing continue until the BL receives and processes all of the data needed from the UI for a given scenario.

### SUMMARY

The present disclosure describes a system that, in one implementation, includes a user interface, business logic, and an intermediate layer. The user interface is able to collect data from a user and the business logic is able to process data collected by the user interface. The intermediate layer is interposed between the user interface and the business logic to rearrange data collected by the user interface into a format that is optimized for processing by the business logic. The system can conduct a data flow between the user interface and the business logic through the intermediate layer, in which the data flow can be initiated by one or more actions of the user interface such as opening a user interface and entering data in the user interface.

The intermediate layer can optimize the rearrangement of data for the business logic. In one case, the rearrangement of data collected by the user interface can include data collection from the user interface and translating the collected data for the business logic. The intermediate layer may provide a buffering of data flow between the user interface and the business logic, in which the buffering of data flow may enable the system to perform batch processing of a number of business processes. The business logic may include a general business logic layer for common business functions and applications, and the intermediate layer may format the data for use in the general business logic layer. The intermediate layer may perform one or more operations on one or more objects to reduce an amount of business processes performed by the business logic, such as collecting and formatting one or more classes of objects.

The system may also include an object model controller to associate the data from the user interface with an object, in which the intermediate layer can receive the object from the object model controller. The object model controller may send data requests to the intermediate layer and may include an object-oriented interface. The data requests may include a read data request, a modify data request, and/or an insert data request.

The system may also include a database to receive data from the business logic and send data to the business logic. The system may also send business logic data to the user interface through the intermediate layer.

In another implementation, the present disclosure describes a method that includes receiving data in a user interface and passing the data from the user interface to an intermediate layer. The intermediate layer may be able to interact with the user interface and a layer of business logic. The method also includes performing one or more operations on the data passed to the intermediate layer and sending data and/or instructions from the intermediate layer to the layer of business logic. The method may also include processing the data and/or instructions in the layer of business logic and sending the processed data and/or processed instructions from the layer of business logic to the user interface. The sending of the processed data and/or instructions may include passing the processed data and/or instructions through the intermediate layer.

The method may also include associating an object with the data received in the user interface, in which the intermediate layer may be able to perform one or more operations on the object. An object model controller can associate an object with the data received from the user interface. The object model controller may allow a user to prevent other users from modifying data until a save data instruction is received in the user interface. The intermediate layer may be able to perform the following operations: receiving an instruction from the object model controller; performing one or more operations relating to the received instruction; and issuing one or more instructions to the layer of business logic. The intermediate layer can determine whether the received instruction from the object model controller includes a known object, an unknown object, and/or a modification of a known object. In response to the received instruction from the object model controller, the intermediate layer may be able to perform any of the following operations: instructing the layer of business logic to approve previous instructions and data entries; instructing the layer of business logic to save data in a database; and initializing a framework to enable a user to perform data entry.

The method may further include sending the data from the layer of business logic to a database and saving the data in the database upon receiving the data from the layer of business logic. The intermediate layer may be able to optimize one or more processes in the layer of business logic and enable batch processing of data entered in the user interface. The intermediate layer may maintain data entries and modifications among various object classes, and the layer of business logic may include common business functions and applications. Also, a data flow between the user interface and the layer of business logic may be initiated by one or more actions of the user interface, such as opening the user interface and/or entering data in the user interface.

In another implementation, an article includes a machine-readable medium storing instructions operable to cause a machine to perform operations. The operations include receiving data in a user interface and passing the data from the user interface to an intermediate layer. The intermediate layer is able to interact with the user interface and a layer of business logic. The operations also include performing one or more operations on the data passed to the intermediate layer and sending data and/or instructions from the intermediate layer to the layer of business logic. Further operations include processing the data and/or instructions in the layer of business logic and sending the processed data and/or processed instructions from the layer of business logic to the user interface. The sending of the processed data and/or instructions includes passing the processed data and/or instructions through the intermediate layer.

The present disclosure also describes a system that, in one implementation, includes a network of computers, business logic, and an intermediate layer. The network of computers includes a database and at least one user interface. The business logic is able to perform a number of business functions and applications. The business logic is also able to process data entered in the user interface and interact with the database. The intermediate layer is able to interact with the user interface and the business logic. The intermediate layer is able to format and rearrange data entered in the user interface to optimize the processing of data in the business logic. A data flow between the user interface and the business logic is conducted through the intermediate layer.

The systems and techniques described here may provide one or more of the following advantages. For example, the intermediate layer can improve the efficiency and speed of the business system, and can allow the user interface to be formatted so that a user can enter larger amounts of data in a more efficient manner. The intermediate layer can permit a more generic implementation of the business logic such that the business logic implementation can be easily transferred among systems that use different user interfaces. Also, the intermediate layer may improve the efficiency of business logic processing by being able to collect, maintain, and optimize the rearrangement of data entries and modifications among various object classes. The intermediate layer may also perform complex formatting and data translation steps that would otherwise have to be implemented and performed in the business logic.

Details of one or more implementations are set forth in the accompanying drawings and the description below. Other features and advantages will be apparent from the description and drawings, and from the claims.

### DRAWING DESCRIPTIONS

FIGS. 1-2 are exemplary diagrams of an intermediate layer positioned between a user interface and a layer of business logic.

FIGS. 3A, 3B are exemplary flow diagrams of data processes.

FIG. 4 shows an exemplary diagram of interactions between the user interface and the business logic layer using the intermediate layer.

FIGS. 5A and 5B show exemplary diagrams of operations that are performed by the intermediate layer.

FIG. 6 shows an exemplary block diagram of a system that is capable of utilizing the intermediate layer.

Like reference symbols in the various drawings indicate like elements.

### DETAILED DESCRIPTION

The following describes various tasks, techniques, and interfaces for implementing an intermediate layer between a user interface and a layer of business logic.

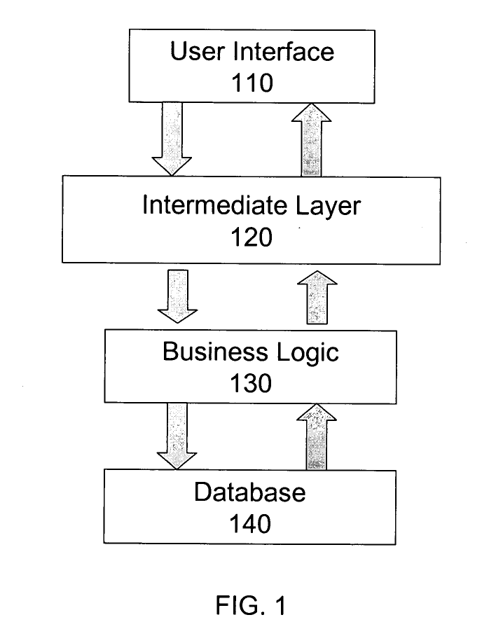

FIG. 1 is a software architecture diagram of an intermediate layer 120 positioned between a user interface 110 and a layer of business logic 130 (e.g., a layer to maintain and process customer accounts). The intermediate layer 120 may control and/or monitor interactions between the UI 110 and the BL layer 130. For example, the intermediate layer 120 can format and translate data and requests between the UI 110 and the BL layer 130. An intermediate layer 120 that is placed between the UI 110 and the BL layer 130 can perform several functions, including collecting data and instructions from the UI 110 and formatting and rearranging the data and instructions for appropriate use in the BL layer 130. In addition, the intermediate layer 120 can collect data and instructions from the BL layer 130 and format and rearrange the data and instructions for appropriate use in the UI 110. In general, the intermediate layer 120 can serve as an intermediary medium or go-between layer for UI data and BL data. The BL layer 130 can interact with information in one or more repositories and/or databases 140 (e.g., databases that store data for customer accounts).

The data from the UI 110 may be part of one or more objects. The objects may have a group of classes or one or more types of object models. For example, a first object may represent the first name of an employee in a business, and a second object may represent the last name (e.g., family name or surname) of that employee. The first and second names together can be grouped into an object class of “employee name.” A third object name may represent the employee's home address, a fourth object may represent the employee's home telephone number, and a fifth object may represent the employee's home email address. These five objects may be grouped in a larger object class referred to as “employee's home information.”

The UI 110 can receive data from a user, such as an employee's home telephone number, and the intermediate layer can receive an object with the employee's home telephone number. The intermediate layer 120 can then add, update, and/or discard this object and other related objects and data before sending the telephone number information to the BL 130. Some examples of intermediate layer operations are shown in one or more diagrams below.

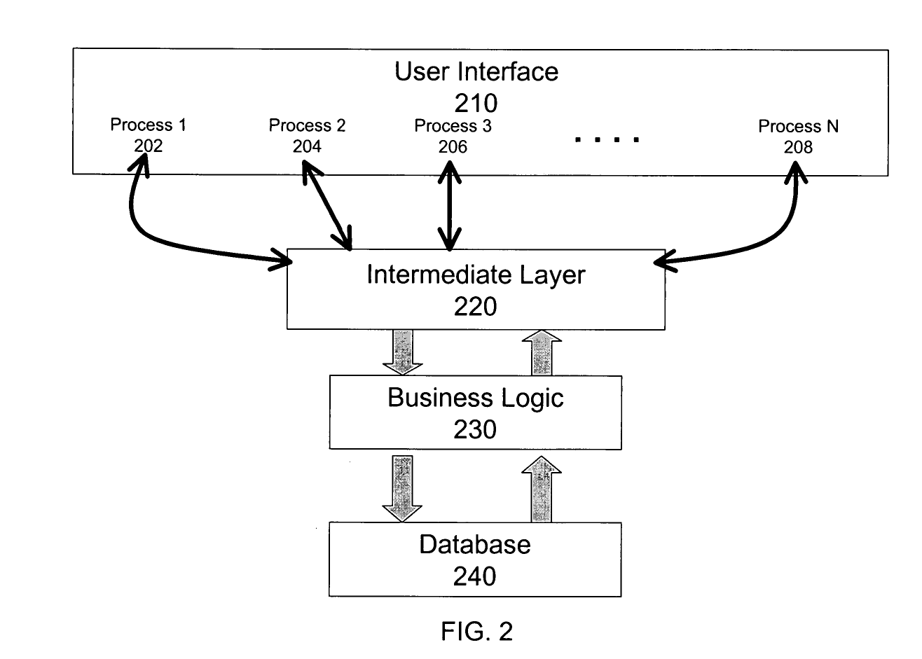

FIG. 2 shows an exemplary diagram of an intermediate software layer 220 positioned between a user interface 210 and a layer of business logic 230. The intermediate layer 210 can collect larger amounts of the data from the UI that may be typically collected prior to processing by the BL. Hence, the data does not have to be entered serially in the UI. The larger amounts of data can be formatted in the intermediate layer 210 and sent to the BL layer 230. As a result, the data does not have to be serially processed and buffered in the BL layer, but rather can be handled in “batch” mode, that is, all at once without intervening human interaction. In one case, the intermediate layer 220 can provide temporary buffering of data until the user has completed entering information for a “batch” of business processes. As a result, the intermediate layer 220 can improve the efficiency of the business system and can allow the UI 210 to be formatted so that a user can enter larger amounts of data.

The intermediate layer 210 may support one or more operations on multiple interdependent attributes of complex business objects. For instance, the UI 210 may have data relating to multiple processes 202, 204, 206, all of which may interact with the intermediate layer 220.

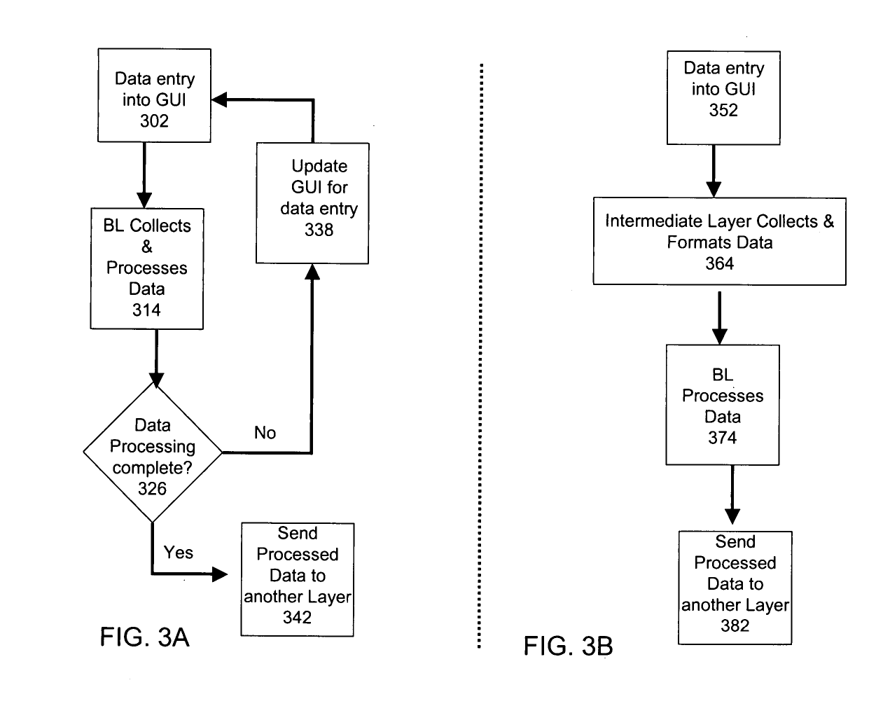

FIGS. 3A, 3B are exemplary flow diagrams of data processes. FIG. 3A shows an exemplary flow diagram for the serial processing of data, and FIG. 3B shows an exemplary flow diagram for the “batch” processing of data. In FIG. 3A, data is entered into a UI 302, and a layer of BL collects the data 314. The BL then processes the data 314, and a determination in made as to whether the data processing is complete 326. In the serial data processing scenario of FIG. 3A, only a portion of the available and/or relevant data has been entered into the user interface at a given time, and additional data is needed for the BL to perform complete processing of all of the available and/or relevant data. In the event that all of the available and/or relevant data has been processed by the BL, the data is sent to another location 342 such as another layer or database. If the BL needs further data from the UI to complete BL processing, a request may be sent to fetch further data from the UI 326. In this case, the UI may be updated and reformatted for new data entry 338. For example, the UI may be updated to include a new menu, toolbar, and/or text field for the new data entry. The user can enter the next portion of data 302 for further BL data collection and processing 314.

Because data collected from the UI typically is not properly formatted for BL use, the collected data ordinarily must be formatted and rearranged before it is provided to the BL for processing. Absent an intermediate layer, the BL would also have to perform these reformatting and rearranging functions. However, by interposing an intermediate layer between the UI and the BL, the data collected by the UI may be formatted into an optimal arrangement before reaching the BL layer for processing, thereby decreasing complexity and enhancing efficiency and through-put. The optimal arrangement typically would vary with the type of application, specifics of the UI and BL, and the nature of the data being collected and processed. In general, an optimized arrangement of collected data would be that which minimizes processing by the BL to achieve the desired results and in an efficient and timely manner.

FIG. 3B shows a flow diagram in which an intermediate layer performs the functions of collecting and formatting data 364 that was entered in the UI 352. The BL can provide the functionality of processing the data 374 from the intermediate layer, and the processed data can then be sent to another location 382, such as another layer or database.

The BL layer can be optimized to perform processing functions, and need not necessarily have be configured to also perform data formatting or otherwise facilitate additional data collection. As a result, the BL layer can be more streamlined. For example, the BL layer may be implemented more generically, and may not have to be tailored to receive data for specific user interfaces. In another aspect, the BL layer implementation may be more transferable. The “transferable” implementation may allow the BL layer to be used with a larger variety of user interfaces and/or a larger variety of business systems. For example, the BL layer may be able to process data in disparate applications for which the user interfaces do not relate to the same line of business. Instead of having a BL layer that only processes data with a user interface relating to clothing stores, for example, the BL layer may also be able to handle common processing functions on data with user interfaces relating to computer stores (e.g., the purchasing and shipping of goods). In other cases, the intermediate layer may be tailored to receive data from specific types of user interfaces (e.g., user interfaces for large amounts of data entry), and format that data to be sent to a general BL layer, in which the general BL may be used for common business functions and applications (e.g., maintaining inventory or employee data). The common business functions and applications may be generic and/or frequently-used business functions (e.g., employee data entry). The common business functions may also include business functions that can be used across multiple types of businesses (e.g., employee data entry for computer businesses, employee data entry for hospitals, and employee data entry for retail stores). Because the BL layer does not necessarily include the functionality of the data collection and formatting from the UI, the BL layer may provide data processing with less delay and more efficiency.

The intermediate layer can also provide the advantage of allowing a larger amount of data entry to be entered into the UI in a single step. The data entry may, for example, include all of the data that the BL may need for processing in a single step. The BL may request additional data 338 as needed as in FIG. 3A. But the use of the intermediate layer 364 can reduce the likelihood of such data requests and/or reduce the number of such additional data requests since the intermediate layer 364 can handle collection and formatting tasks, rather than requiring those tasks to be handled exclusively in the BL.

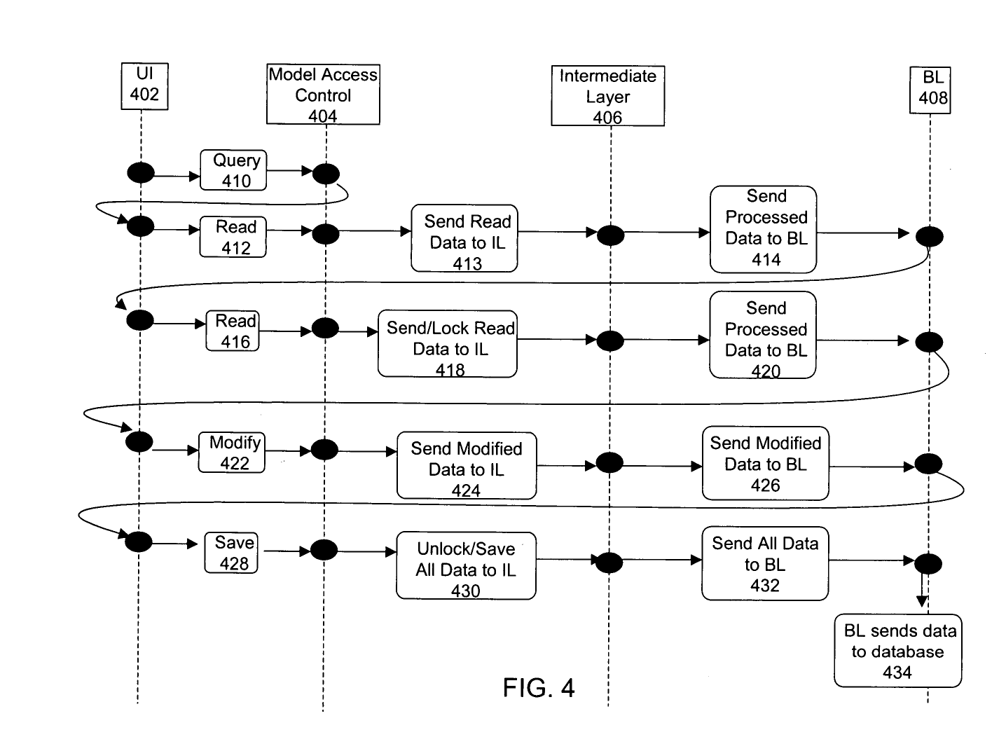

FIG. 4 shows an exemplary diagram of interactions between the UI and the BL using the intermediate layer. FIG. 4 shows columns representing layers (e.g., UI 402, BL 408) with one or more layer operations (e.g., send read data to IL 412). The UI 402 may receive data from a user, and a model access controller (MAC) 404 (object model controller) can associate the data with an object and send data requests to the intermediate layer 406 and/or the UI 402. The intermediate layer can translate (e.g., format or rearrange) the data to the BL 408. If additional information is not needed from the UI 408, then the data can be saved in a database.

The entered data (e.g., employee's home telephone number) may be part of a model class (e.g., “employee's home information”). In one case, the entered data may be entered into a field in the UI in which the field is associated with a particular model class. In another case, a separate model controller 404 (object model controller) may receive entries from the UI and associate the data into object model classes to send to the intermediate layer 406. The MAC 404 may associate objects into one or more model classes based on various criteria. For example, the MAC may associate objects into model access classes based on a type of UI (e.g., a UI for entry of employee data, a UI to set up customer account data, or a UI for a particular type of business), based on the data field in the UI (e.g., an employee's first name data field), or based on the type of information (e.g., data with certain text characters). The MAC 404 may have functionality to map, relate, or link data for one or more object classes. The MAC 404 may have an object-oriented interface and may send data requests (e.g., read, modify, insert) to the intermediate layer 406.

In the example shown in FIG. 4, a user can initiate a query 410 in the UI 402, and the MAC 404 can send a request to the UI 402 for data. The data flow in FIG. 4 is initiated or triggered by an action in the user interface. The user enters the data in the UI 402. The UI 402 sends the data 412 to the MAC 404, associates that data in an object class, and sends the data 413 to the intermediate layer 406. The intermediate layer 406 translates the data and sends the data to the BL 408. The BL 408 may then request additional data from the UI by sending a request through the intermediate layer 406 and the MAC 404 (object model controller).

The MAC 404 may also have the functionality to “lock” the object 418. The “lock” function may prohibit other users of a system in other user interfaces from modifying the object. The user may select one specific object (e.g., an employee number object), and specify in the UI 402 that object modifications are to be locked from other users. In this example, locked objects may only be modified 422 by the user of the interface. When the user elects to save the data (e.g., by pressing a “save” button in the UI 402), the save request 428 is sent to the MAC 404. The MAC 404 can notify 430 the intermediate layer 406 that all data changes are to be saved. The BL 408 sends the data to be saved in a database 434. If a user sets an object lock 418, then the object can be unlocked 430 when or after the data is saved.

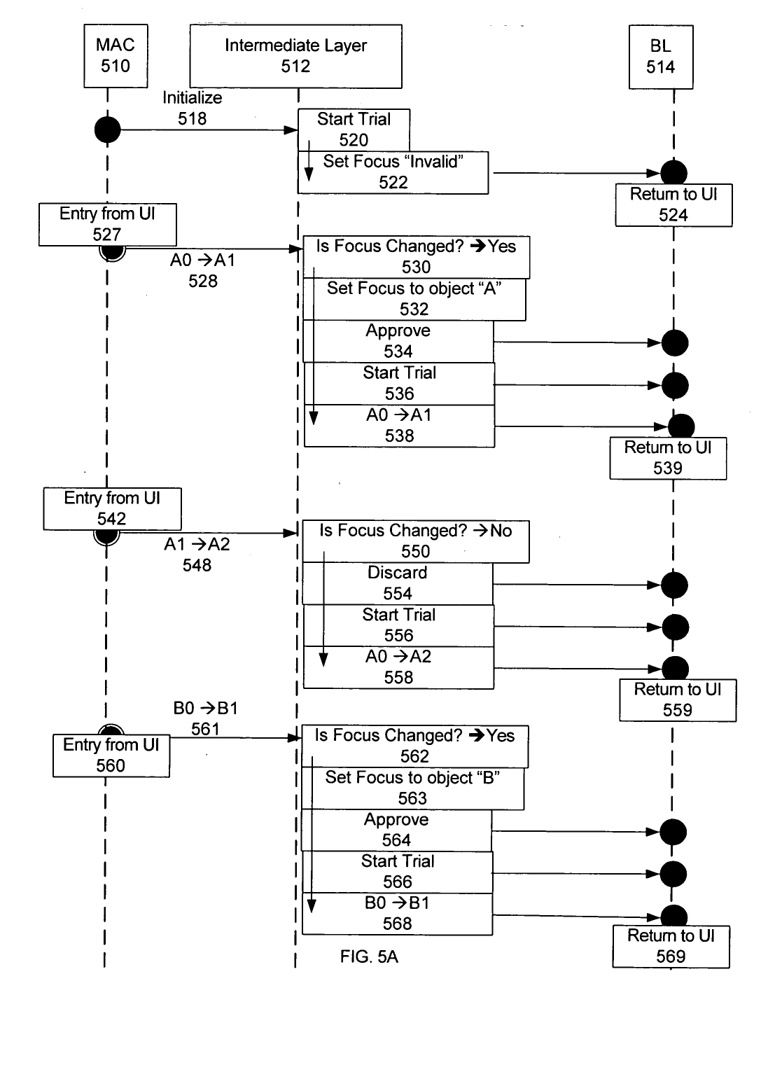

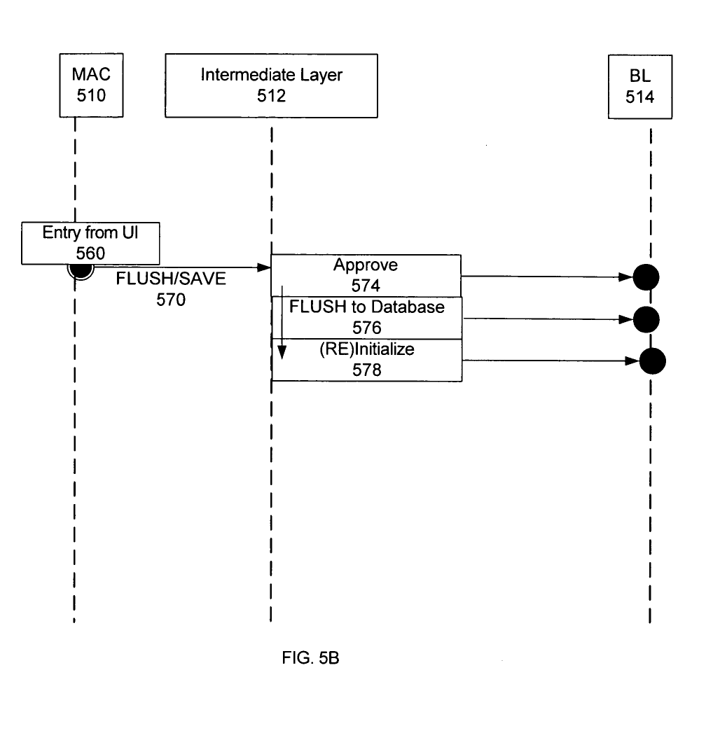

FIGS. 5A and 5B show diagrams of some of the operations that may be performed by the intermediate layer. FIGS. 5A and 5B show that the intermediate layer can perform a number of steps to format or translate the data entered from a UI to the BL.

In FIG. 5A, a MAC (object model controller) can send an initialize request 518 to the intermediate layer when a user interface is opened by a user. The user can initiate the data flow shown in FIGS. 5A and 5B with the user interface. In this example, the intermediate layer 512 receives one input from the MAC 510, performs one or more steps, then sends one or more outputs or requests to the BL 514. After an initialization request is received, the intermediate layer 520 begins a new trial or a number of operations for an object. During initialization, the intermediate layer 512 has not yet received an object from the MAC 510, and the MAC has not received data from the UI. As a result, the intermediate layer 512 cannot target or focus operations on a particular object (e.g., an “invalid” object focus 522), and the intermediate layer 512 notifies the BL that the intermediate layer 512 did not handle an object. The BL 514 can then send a data request 524 to the UI through the intermediate layer and the MAC.

A user can enter data 527 in the UI, and the MAC 510 can associate an object (e.g., object “A”) with the data entry. The MAC can indicate that the object has changed from an empty or “null” state to a state with new data 528 (e.g., A0→A1). The new data may be an entry for an employee number for an employee object (e.g., employee number “12345” for an “employee's information” object). The intermediate layer 512 can determine if there has been a modification of a current/known object or if there is a new/unknown object. An object is “current” or “known” if the object has been previously introduced to the intermediate layer for that trail or session, otherwise the object is “new” or “unknown” to the intermediate layer. If the object is new/unknown to the intermediate layer 512 then there has been an object focus change 530. If the object is not new/known to the intermediate layer 512, but involves a change in the object's state (e.g., modified data), then the object focus has not changed.

Because the object “A” is new or unknown to the intermediate layer 512 then the focus can be changed to “A” 532. The intermediate layer 512 can notify the BL that all changes to any previous objects should be “approved” 534. The intermediate layer 512 can also notify the BL that a new trial or session 536 is started on the object (“A”) 536, and the state of the object is “A1” 538. If the BL 514 has not received a closed, save, or end session request, the BL may request for additional information from the UI via the intermediate layer and the MAC.

In the event that a user modifies data (e.g., employee number “54321”) for the same object (e.g., object “A”), the object's state is changed 548 (e.g., A1→A2). Because operations are performed on the same object, the intermediate layer will not change the focus 550. The intermediate layer 554 can instruct the BL to discard the previous state changes to the object “A” 554 and to start a new trial 556. The intermediate layer 554 can then send the modified state 558 (e.g., A0→A2) to the BL.

In the event that a new object is used (e.g., object “B”), the intermediate layer's focus can be changed 562, 563, and the same steps described above (e.g., steps shown in 534-539) can be performed on the new object. The new object may represent, for example, an employee's start date or organizational title/ranking. Hence, the intermediate layer 554 may be able to recognize different objects (e.g., objects “A” and “B”) and produce changes on those objects (e.g., A0→A2).

FIG. 5B shows the intermediate layer operations when a user has completed the steps of entering data in the UI. The user may “save” all of the data and data modifications (e.g., by selecting a “save” button in the UI). The MAC 510 (object model controller) can send a “save” or “flush” request to the intermediate layer 570. The intermediate layer 512 can instruct the BL 512 to approve previous user entries and/or changes 574, and to flush or send the data and/or objects to a database 576. The intermediate layer 512 may also be responsible for initializing (or re-initializing) the system/framework so that a user can be allowed to start the data entry steps over again.

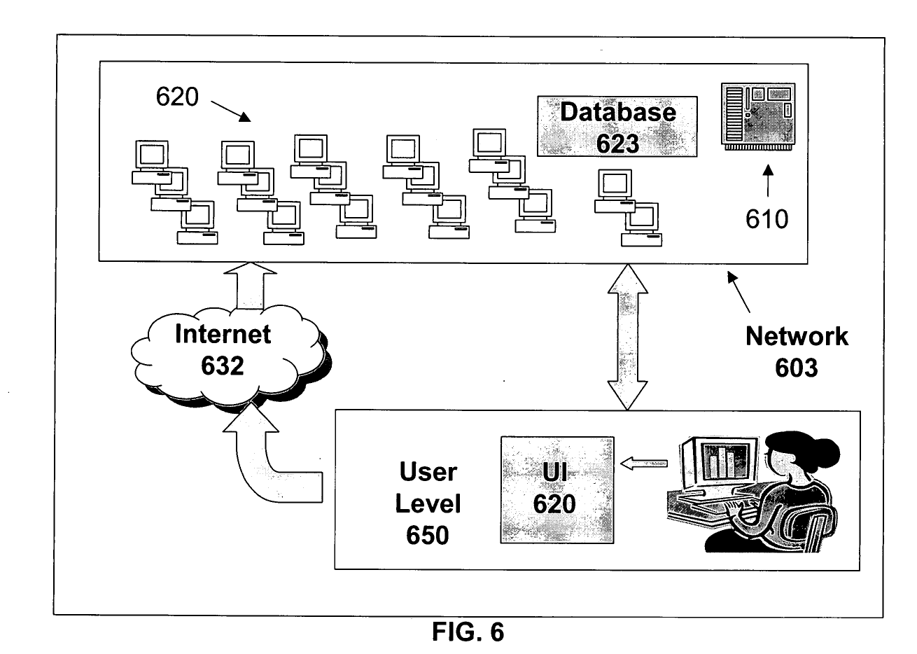

FIG. 6 shows an exemplary block diagram of a system that is capable of utilizing the intermediate layer. The system can have one or more users on one or more computers 620. The computers may be in a network 603 and share a common repository or database 610, 623. A user 650 may be able to connect to the database 610,623 through an enterprise intranet or through the Internet 632. The user may conduct various data entries on a machine with a UI 620. The system may include business logic that is able to perform a number of business functions and applications. The business logic may also be able to process data entered in the UI 620 and interact with the database 610,623. The intermediate layer is able to interact with the UI 620 and the business logic. The intermediate layer is able to format and rearrange data entered in the UI 620 to optimize the processing of data in the business logic. A data flow between the UI 620 and the business logic is conducted through the intermediate layer.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

The software (also known as programs, software tools or code) may include machine instructions for a programmable processor, and can be implemented in a high-level procedural and/or object-oriented programming language, and/or in assembly/machine language. Some exemplary languages may include C, C++, JAVA (by SUN Microsystems), and ABAP (Advanced Business Application Programming). As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on one or more computers each having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface, portal, or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), a wireless local area network (“WLAN”), a personal area network (“PAN”), a mobile communication network using a multiple access technology (e.g., a cellular phone network with Code Division Multiple Access, “CDMA”), and the Internet.

The computing system can include clients and servers. A client and server are generally remote from each other and typically interact through a communication network. The relationship of client and server arises by virtue of computer programs running on the respective computers and having a client-server relationship to each other.

Although only a few implementations have been described in detail above, other modifications are possible. There may be other scenarios that have not been described. For example, the user interface may provide security features that are related to the user. The user's security status may allow only certain data entries and/or modifications. In another example, the operations described in FIGS. 4, 5A, and 5B may be implemented to enhance the workflow of the user—such as guiding a user from simple to complex data entries. In another case, the operations in FIG. 4 may utilize a wizard utility for data entry. The user interfaces described above may be referred to as panels, palettes, pages, views, or portions of other interfaces. The logic flows depicted in FIGS. 3A and 3B do not require the particular order shown, or sequential order, to achieve desirable results.

Other implementations may be within the scope of the following claims.

1. A system comprising:
a user interface adapted to collect data from a user;
business logic configured to process data collected by the user interface; and
an intermediate layer interposed between the user interface and the business logic and configured to rearrange data collected by the user interface into a format that is optimized for processing by the business logic.

2. The system of claim 1 wherein the system is adapted to conduct a data flow between the user interface and the business logic through the intermediate layer.

3. The system of claim 2 wherein the data flow is initiated by one or more actions of the user interface, wherein the one or more actions comprise any one of an opening of a user interface and an entering of data in the user interface.

4. The system of claim 1 wherein the intermediate layer is further adapted to optimize the arrangement of data for the business logic, wherein the rearrangement of data collected by the user interface comprises data collection from the user interface and translating the collected data for the business logic.

5. The system of claim 1 wherein the intermediate layer is configured to provide a buffering of data flow between the user interface and the business logic, wherein the buffering of data flow enables the system to perform batch processing of a plurality of business processes.

6. The system of claim 1 wherein the business logic comprises a general business logic layer for common business functions and applications, wherein the intermediate layer is further adapted to format the data for use in the general business logic layer.

7. The system of claim 1 wherein the intermediate layer is adapted to perform one or more operations on one or more objects to reduce an amount of business processes performed by the business logic, wherein the one or more operations on the one or more objects comprise collecting and formatting one or more classes of objects.

8. The system of claim 1 further comprising an object model controller to associate the data from the user interface with an object, wherein the intermediate layer is adapted to receive the object from the object model controller.

9. The system of claim 8 wherein the object model controller is adapted to send data requests to the intermediate layer, wherein the data requests comprise any one of a read data request, a modify data request, and an insert data request, and wherein the object model controller further comprises an object-oriented interface.

10. The system of claim 1 further comprising a database adapted to receive data from the business logic and send data to the business logic, and wherein the system is adapted to send business logic data to the user interface through the intermediate layer.

11. A method comprising:
receiving data in a user interface;
passing the data from the user interface to an intermediate layer, the intermediate layer being adapted to interact with the user interface and a layer of business logic;
performing one or more operations on the data passed to the intermediate layer; and
sending any one of data and instructions from the intermediate layer to the layer of business logic.

12. The method of claim 11 further comprising:
processing any one of the data and instructions in the layer of business logic; and
sending any one of processed data and processed instructions from the layer of business logic to the user interface, wherein the sending of any one of processed data and processed instructions comprises passing the any one of processed data and processed instructions through the intermediate layer.

13. The method of claim 11 further comprising associating an object with the data received in the user interface, wherein the intermediate layer is further adapted to perform one or more operations on the object.

14. The method of claim 13 wherein an object model controller associates an object with the data received from the user interface, wherein the object model controller is configured to allow a user to prevent other users from modifying data until a save data instruction is received in the user interface.

15. The method of claim 14 wherein the intermediate layer is adapted to perform the following operations: receiving an instruction from the object model controller; performing one or more operations relating to the received instruction; and issuing one or more instructions to the layer of business logic.

16. The method of claim 15 wherein the intermediate layer determines whether the received instruction from the object model controller comprises any one of a known object, an unknown object, or a modification of a known object.

17. The method of claim 16 wherein, in response to the received instruction from the object model controller, the intermediate layer is further adapted to perform any of the following operations: instructing the layer of business logic to approve previous instructions and data entries; instructing the layer of business logic to save data in a database; and initializing a framework to enable a user to perform data entry.

18. The method of claim 11 further comprising:
sending the data from the layer of business logic to a database; and
saving the data in the database upon receiving the data from the layer of business logic.

19. The method of claim 11 wherein the intermediate layer is adapted to optimize one or more processes in the layer of business logic, and wherein the intermediate layer enables batch processing of data entered in the user interface.

20. The method of claim 11 wherein the intermediate layer maintains data entries and modifications among various object classes, and wherein the layer of business logic comprises common business functions and applications.

21. The method of claim 11 wherein a data flow between the user interface and the layer of business logic is initiated by one or more actions of the user interface, wherein the one or more actions of the user interface comprise any one of an opening of the user interface and a data entry in the user interface.

22. An article comprising a machine-readable medium storing instructions operable to cause a machine to perform operations comprising:
receiving data in a user interface;
passing the data from the user interface to an intermediate layer, the intermediate layer being adapted to interact with the user interface and a layer of business logic;
performing one or more operations on the data passed to the intermediate layer;
sending any one of data and instructions from the intermediate layer to the layer of business logic;
processing any one of the data and instructions in the layer of business logic; and
sending any one of processed data and processed instructions from the layer of business logic to the user interface, wherein the sending of any one of processed data and processed instructions comprises passing the any one of processed data and processed instructions through the intermediate layer.

23. A system comprising:
a network of computers, wherein the network of computers comprises a database and at least one user interface;
a plurality of business logic adapted to perform a plurality of business functions and applications, wherein the plurality of business logic is further adapted to process data entered in the at least one user interface, and wherein the plurality of business logic interacts with the database; and
an intermediate layer interacting with the at least one user interface and the plurality of business logic, wherein the intermediate layer is adapted to format and rearrange data entered in the user interface to optimize the processing of data in the plurality of business logic, and wherein a data flow between the at least one user interface and the plurality of business logic is conducted through the intermediate layer.
